(19) United States
(12) Patent Application Publication
(10) Pub. No.: US 2002/0023176 A1
(43) Pub. Date: Feb. 21, 2002

(54) Collaborative process management system and method

(76) Inventor: Larry Kwicinski, Woodside, CA (US)

Correspondence Address: SHAW PITTMAN, 1650 TYSONS BLVD., MCLEAN, VA, 22102, US

(21) Appl. No.: 09/876,034

(22) Filed: Jun. 8, 2001

Related U.S. Application Data
(60) Provisional application No. 60/210,457, filed on Jun. 9, 2000.
(60) Provisional application No. 60/215,766, filed on Jun. 30, 2000.

(51) Int. Cl. G06F 9/44

(52) U.S. Cl. 709/317; 709/205; 706/45; 705/35

(57) ABSTRACT

A system for and method of providing collaborative process management including identifying agents, determining environmental factors, assessing the agents in view of the environmental factors, creating an online environment in which the agents can communicate with one another and collaborate, embedding a process in the environment, performing the process, and continually supporting, facilitating and promoting collaboration among the agents during each step of the process. A modular software system architecture with tightly bound modules provides the means by which collaboration is supported and encouraged.

This application claims the benefit of U.S. Provisional Application Nos. 60/210,457, filed Jun. 9, 2000 and 60/215,766 filed Jun. 30, 2000.

### BACKGROUND

1. Field of the Invention

The present invention is directed to a computer system programmed to facilitate collaboration. More particularly, the present invention is directed to a system and method that optimizes the interaction of agents operating in a dynamic environment, influenced by environmental factors, and that drastically improves the effectiveness and efficiency of agents involved in a given process, through the capability to adapt and react immediately to changes in any of the factors in the overall process system.

2. Background of the Invention

Much work has been focused throughout the preceding two decades to enhance the effectiveness of processes through the application of computer technology. Independent Software Vendors (ISVs) have published numerous software systems that have attempted to radically increase the effectiveness of processes. These past efforts have typically focused on a specific element of a process system. For example, several ISVs have incorporated the capability to define a process within their published software offering that allows the ability to define a process, and ensure and track compliance to the pre-defined process. Other ISVs have identified a specific environmental factor and embedded a software solution within their published software offering. Similarly, functional capabilities such as collaboration have been “bolted on” to existing software programs to offer a more complete solution. Also, several ISVs have recognized the importance of agents in the definition of processes and offer capabilities such as e-mail integration, voicemail integration and interaction with other computer systems.

Though advances in the management of processes have been realized with some of the past initiatives, these initiatives have realized only limited increases in efficiency and effectiveness of overall processes. More specifically, past solutions tend to focus on defining linear processes and embedding them into a specific computer system that offers no recognition of the dynamic nature of the majority of processes and the numerous intangible factors that can have significant impact on the overall process. The resulting computer system receives initial adoption in the expectation that process efficiency will increase, but slowly usage of the system wanes as agents working in the process environment face the limitations of these prior art solutions to assist in the management of all factors that operate in the “process system”. What were initially enthusiastic users, turn to other methods to perform the processes and use the system only because they are mandated to do so by corporate ruling. These resulting static attempts to assist in the management of processes, have not led to sustainable increases in process effectiveness or efficiency, as they are incapable of dealing with all, or even a substantial number of, the dynamic factors at play in the majority of processes used in the business environment of today.

The inventors of the present invention have also, in the past, initiated several attempts at increasing the effectiveness of managing processes specifically focused on Strategic Account Planning processes. Throughout several projects, attempts were made to adapt processes to computer systems, and to use existing solutions in recognition of the importance of some specific environment elements. In one such attempt, the Strategic Account Planning process for a large company was adapted to incorporate a “collaboration” computer system offered from an ISV. In this case, though the function offered by the “collaboration” system was useful, it was disjointed from the actual process and other environment elements and agents, and as a result could not offer sustained process effectiveness. In view of the aforementioned unsatisfactory experiences with non-integrated collaborative software offerings and the present inventors' own experiences in this field, it became apparent that a better solution was necessary to fully achieve the level of collaboration that can contribute added value to an on-going process.

### SUMMARY OF THE INVENTION

It is therefore an object of the present invention to provide a method of and system for facilitating collaboration.

It is also an object of the present invention to provide a collaboration method and system that recognizes four distinct elements, namely, a process, agents, environment and environmental factors and coordinates among these elements to support collaborative process management.

It is another object of the present invention to provide a collaborative process management tool that is embodied in a distributed computer system.

It is still another object of the present invention to provide web-based collaborative process management that is operable both on-line and off-line.

It is also an object of the present invention to provide a system for and method of collaborative process management that employs integrated customer information and a knowledgebase.

It is another object of the present invention to provide a collaborative process management method and system that is embodied in a computer system that is focused primarily on strategic account planning.

It is yet another object of the present invention to provide a collaborative process management system and method that enhances the strategic planning process by funneling all, or substantially all, communications for a particular process into collaboration mechanisms.

These and other objects of the present invention are achieved by a system and method that is the result of having observed numerous projects that have attempted to automate Strategic Account Planning (SAP) by embedding SAP processes in computers. These observations have led the inventors to recognize that there are four distinct, but inter-related elements that are preferably recognized in the design of a computer system if it is to be effective over a long term in the management of processes. The recognition, and automated integration and inter-relation, of this complete set of factors that influences a process allows for the effective management thereof. The automated integration and inter-relation, which is considered to be a fundamental aspect of the present invention, is referred to herein as Collaborative Process Management (CPM).

Collaborative Process Management, or CPM, is based on the identification of four key elements that are interrelated in the execution of any defined process. Preferably, all four elements are designed into a seamless solution so that effective process management can occur. The first of these elements is the process itself that is typically defined as a series of steps required to achieve a certain objective. The second element comprises several agents that interact with each other in an ever-changing manner throughout the execution of the process. The third element is the environment, defined as a number of tangible factors that bound the process, and that influence both the process and the agents in an ever-changing manner. The fourth element is a set of environmental factors that is defined as a set of intangible factors that exerts a strong influence on the execution of the process.

In a representative strategic account planning embodiment of the present invention, collaboration structure and guidelines are achieved by embedding an account planning process into the Collaborative Process Management scheme. While some of the main steps in the overall account planning process become fixed as a result of this combination of the two entities (i.e., SAP & CPM), a team (e.g., a group of salespeople) nevertheless has a great deal of flexibility to create new dialogue categories (as will be more fully explained) within each of the main steps. This enables team members to build, at the appropriate time, a process that fits their specific environment.

The preferred implementation of the system and method is web browser-based software tool that allows for access from any location, assuming world wide web connectivity is available. The inventive Collaborative Process Management system and method also allows users to move iteratively throughout the process. That is, user interaction in the process is not necessarily linear or need to be sequential. Finally, while the present invention is described with respect to account planning, it should be understood by those skilled in the art that any process can be embedded in the CPM system and method of the present invention.

In general terms, the present invention comprises both hardware and software components. The hardware components include servers and computers connected to the servers, typically via an electronic network such as a local area network or the Internet. The servers run software that enables the various functions of the present invention. More specifically, the software preferably comprises architecturally separate modules that are tightly bound to one another and thereby offer a seamless “face” to a user of the software. The software provides a plurality of screens, preferably displayed via a web browser, that aggregate several existing communications channels, such as email and messaging services, along with other collaboration tools, such as action items lists and common database access. Depending on access privileges, a user, referred to herein as one type “agent,” can log on to the system and enter into on-going, iterative, collaboration with colleagues and outsiders who may be given access. Since the software takes into account and is designed to recognize the four elements associated with a process, the present invention provides a uniquely efficient and powerful process management tool as compared to prior art systems and methods.

A more detailed description of the present invention, in conjunction with accompanying drawings, follows.

### BRIEF DESCRIPTION OF THE DRAWINGS

FIG. 1 illustrates the agents that are involved in the processes applicable to the present invention.

FIG. 2 illustrates the environment elements that are influential in the processes applicable to the present invention.

FIG. 3 illustrates the several environmental factors that are influential in the processes applicable to the present invention.

FIG. 4 is a screen shot of an exemplary SAP structure that employs CPM in accordance with the present invention.

FIG. 5 is a screen shot of an exemplary template used to assess an opportunity in accordance with the present invention.

FIG. 6 shows an exemplary screen of how individual agents are granted specific roles within the CPM environment in accordance with the present invention.

FIG. 7 shows how the access rights for an agent can be tailored to each specific step in the SAP process in accordance with the present invention.

FIG. 8 illustrates how information is maintained regarding the various agents involved in the SAP process and an indication of their role in the SAP process in accordance with the present invention.

FIG. 9 illustrates an exemplary screen that presents information that is used to provide interface capability with other computer systems (e.g., sales forecasting), provides corporate management information regarding the total revenue expectation for various accounts, and provides information to a sales person regarding new collaboration threads and action items that he/she needs to review and take action on.

FIG. 10 shows integration with e-mail for outbound e-mail messages in accordance with the present invention.

FIG. 11 shows an exemplary action item screen in accordance with the present invention.

FIG. 12 illustrates a portal to a knowledgebase in accordance with the present invention.

FIG. 13 is a screen shot of an exemplary asynchronous communication in accordance with the present invention.

FIG. 14 is a schematic diagram of the integrated architecture of the CPM environment in accordance with the present invention.

FIG. 15 is a diagram depicting online/offline architecture in accordance with the present invention.

FIG. 16 illustrates an architecture for determining the upgrade status of an environment and for upgrading the environment to current/correct version.

FIG. 17 presents the various groupings of responsibilities or main task areas that SAP team members perform in accordance with the present invention.

FIG. 18 is a flow chart of the initial stage of SAP in accordance with the present invention.

FIG. 19 is a flow chart of the iterative work process that agents perform on a continual basis in accordance with the present invention.

FIG. 20 is a block diagram that outlines the collaborative process for effective SAP processes.

### DETAILED DESCRIPTION OF THE INVENTION

As explained in summary above, Collaborative Process Management, or CPM, is based on the identification of four key elements that are interrelated in the execution of any defined process. In the illustrative embodiment of the present invention, all four of these elements are manifested in a software tool that is accessible via the Internet, thereby making it possible for effective process management to occur. The four elements are:

The process itself, which is typically defined as a series of steps required to achieve a certain objective;

A number of agents that interact with each other in an ever-changing manner throughout the execution of the process;

The environment, which is defined as a number of tangible factors that bound the process, and that influence both the process and the agents in an ever-changing manner; and

A set of environmental factors that is defined as a set of intangible factors that exerts a strong influence on the execution of the process.

A more detailed description of each of the aforementioned elements is set for the forth below

1. The Process

The definition of a process is the heart of the Collaborative Process Management (CPM) system. In its simplest form, a process definition is represented as a series of steps that, once accomplished, result in the achievement of a specific goal. Previous representations of process definitions have appeared as indented hierarchies or steps in a specific workflow.

In CPM, the definition of a process involves the integration of several environmental factors and as a result, influences the design of how the process is presented in the computer system. A balance must exist, for example, between the need of a corporation for consistency and the recognition that the real environment where the process executes, is dynamic. The resulting process definition is, therefore, structured when viewed through the static view of a specific computer page, but intuitively provides for an iterative process, a recognition of the psychological need of the person using the computer system, and the interaction with other agents. These capabilities are all tightly integrated into the process and can be either triggered for use by a user of the system, or though intelligent agents embedded within the computer system. The system user can be guided and/or presented with information that can assist them in performing the specific piece of the process they are working on.

2. The Agents

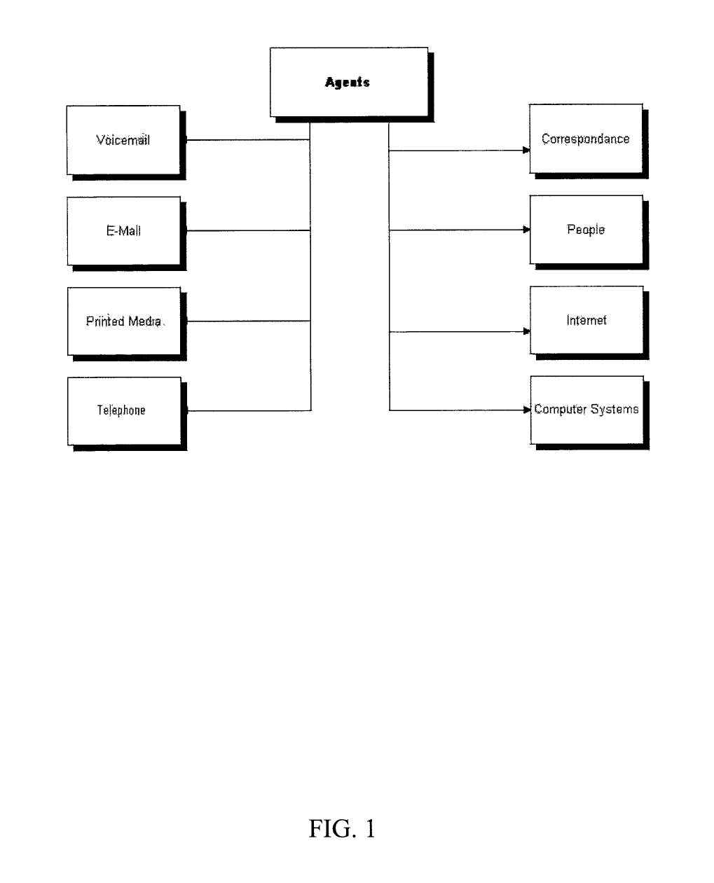

The agents involved in any process system can be categorized in three groups. The first is people, which comprises either actual users of the computer system or individuals who play a part in the process as reviewers of information, recipients of information, or sources of information. The second category of agents is technology and is preferably comprised of other computer systems (e.g., forecasting systems, customer contact databases, Internet) that act as either sources of information for a process, recipients of information from the process, or as technology enablers. The third category is correspondence and information. Correspondence and information is embedded in the process through means of integration with voicemail, e-mail, telephone, printed media, and public/private sources accessible through technology. FIG. 1 illustrates the several types of agents that are contemplated to be within the scope of the present invention.

3. The Environment

The environment defines the boundaries of the process and puts the specific process in context of the real world within which it executes. Elements of the environment are tangible, can be described, and have an important influence on the outcome of any process. Both the process and agents as described above are important elements of the environment. The technical architecture is also an important element for the execution of a process as it defines how various agents will be able to interact with the process. Significant to the effectiveness of process management is that agents have no limitation to their access to the system where the process is being worked on. Fundamental to this requirement is the ability for agents to work on a process while either connected to a network or as a standalone user, unconnected to any network.

The physical attributes of the process are important elements and will define the optimum method for various agents to work with the process as defined. Location, time zone, speed of connection when attached to a network and physical proximity to other agents are all factors in effectively managing a process. Customer Information and Knowledgebase both provide stores of information that can significantly aid the execution of the process. Very important is the method and timing of making this information available to an agent as they are working on relevant steps in a process.

In the example of Customer information, key information is stored to describe an individual of the customer's organization and includes name, position title, level in the organization hierarchy, their language of choice for communication, and their physical location and contact information. In the case of the knowledgebase, any agent involved in the SAP process can store items of importance to either the process or the team. These items comprise, for example, hints, guidelines, advice, training modules, past experiences, and case studies that are all deemed supportive of the process. Due to the integrated nature of the invention, these various items are available to the various agents working on the process within the context of the specific task that is being worked on. As an example, a SAP team member who has received skills to operate the current invention, is working on a step in the SAP process called “Determine customer's relative size in its market.” In all cases, the knowledgebase is directly accessible and can be used in different manners all depending on the need of the team member. If the team member is relatively new to the team, they may choose to review case studies and past experiences with this customer. Guidance will be offered to this person to assist in them completing the process.

One of the most important factors in the environment is collaboration. It is fundamental to process execution that the interplay of agents creates synergistic opportunities that can only be recognized when the agents are able to collaborate immediately in the context of the process they are jointly working on. This collaboration is tightly woven into the process environment, in accordance with the present invention, in order for breakthrough effectiveness to be achieved and sustained. The ability for agents to collaborate directly within a step in a process not only enables the agents collaborating to increase their effectiveness, but because the product of their collaboration becomes tightly coupled with the process step, other agents can benefit from the collaborative work of others. The incorporation of the various environmental factors into the design of this collaborative capability is a key element of this invention.

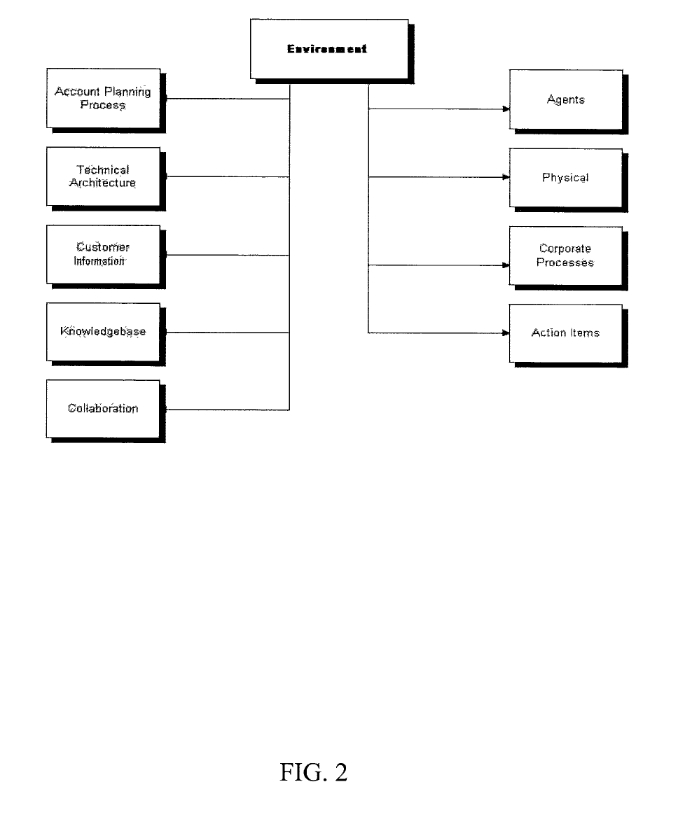

As an example, each user of the CPM system brings with him/her a different set of skills and knowledge, a different preference for interacting with other agents and psychological make-ups that influence the manner that they approach collaboration. The design of the current invention takes these factors into consideration and offers each user a way of collaborating that best fits their style and thus ensures long term sustainability of their collaboration. Users most comfortable with the more asynchronous method of using e-mail can continue to do so, but the various e-mail messages are captured in the context of the process step item, and are made available for all team members to review. Users with strong preferences for the telephone, can also fully participate in the collaboration through the use of various CTI, and voice recognition software solutions. In both of these situations, the CPM system adapts to the mode of working that the agent is most comfortable with, but enables the team members to benefit from the work of other team members. FIG. 2 illustrates the several environments contemplated by and addressed by the collaboration system and method of the present invention.

4. The Environmental Factors

Within the environment, there are several intangible factors that are important for the success of any process. An understanding of the psychology of the human agent who is a user of the computer system is very important in order to ensure that the way that the process is presented to the agent is done in a manner that will encourage the agent to be motivated to continually use the system to perform the given process. Additionally, the skills and knowledge of a specific agent is an important factor, and one that varies from individual to individual. The computer system preferably recognizes this variability and presents knowledge to the agent in the right context and exactly when the knowledge is most useful. Likewise, skills enhancement are targeted at the correct level and timing to enable the agent to most effectively complete the process.

Though the goal of most SAP team members is to identify and close new sales, each account team, and even each member of an account team has differing approaches to achieving the goal. The blend of the interplay among the various environmental factors has led to a flexible design of the CPM system. In a situation where the corporate culture demands rigid conformance to a certain order in the execution of a process, the rules are defined in the CPM system and individuals are guided through the process and offered support through information stored in the knowledgebase. In a situation where there is not a strong conformance to process, agents can move from one process step to another and can partially complete a step and move onto another step. In both of these situations, the same CPM system is used, and system set-up rules are defined to allow both user communities to process their work effectively.

An understanding of the corporate culture is also important to ensure that process management effectiveness is realized. Each specific organization has a “culture” that is unique and, because it is based to a certain extent upon individuals, changes over time. Flexibility in design of the computer system in the rigidity of processes, management reporting, and level of integration of various agents is important to increase and maintain process effectiveness over time. This is accomplished by allowing organizations to determine the rigidity of conformance that is required for agents executing a process. The level of management reporting is also significant in creating a balance between the SAP team member desire to only report revenue opportunities with high likelihood of success, and the management desire to know all potential revenue opportunities. Without recognizing and designing these features into the CPM system, one or both parties feel betrayed and eventually their effectiveness will decline. Integration with other agents as computer systems, is accomplished by using standard Application Programming Interfaces and by passing data using these standard interface formats.

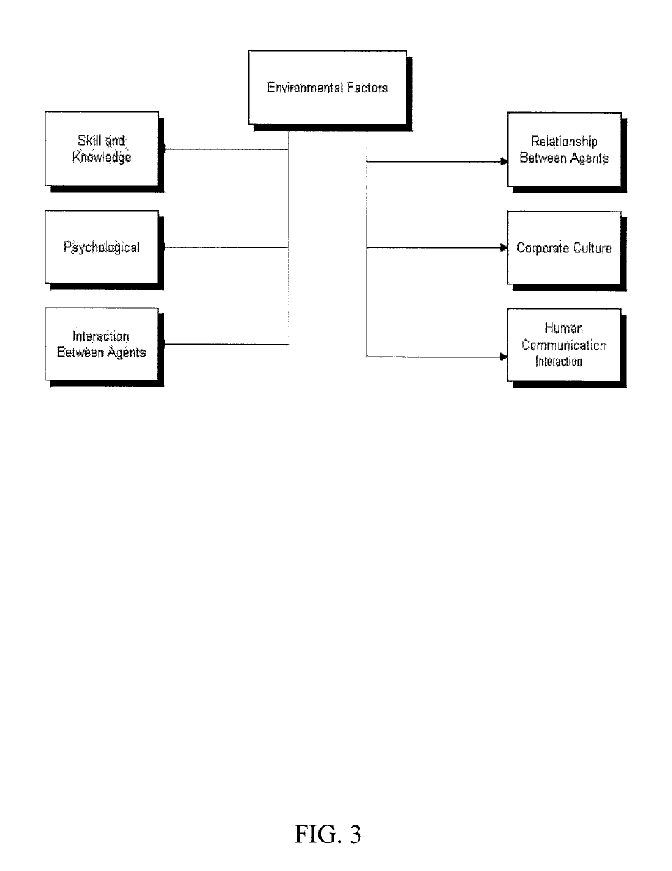

An important group of environmental factors relates to the relationships between agents. It is important to realize that the relationship between agents can have a profound impact on the effectiveness of a process. Peer, manager, and partner relationships involve different dynamics and individual agents will thus require different communication methods in dealing among each other. The interaction between agents that is based on fundamentals of human communication is a very important factor in process management. The clarity of communication and the context within which the communication occurs is important to enabling agents to communicate effectively in near real-time, and becomes critical for other agents to comprehend the meaning and outcome of interactions that they themselves were not involved with. This fundamental understanding of the importance of the various communication “threads” that occur between agents, the context of these “threads”, and the importance to overall process effectiveness of other agents reviewing the “threads” at another point in time, is a key element of the current invention. FIG. 3 illustrates the foregoing environmental factors.

### Representative Embodiment

### Collaborative Process Management as applied to Strategic Account Planning

The present invention has been embodied in a computer system that is focused on Strategic Account Planning (SAP) processes. The inventors have created two distinct systems that have been based on two different technology platforms. For the first technology platform, a standard Microsoft development environment was used and resulted in a system that executes on a Microsoft NT operating system and uses SQL Server as the database engine. In the second technology platform, an Enterprise Java Beans architecture was used and has resulted in a Java based system running on a Solaris Unix operating system and using Oracle as the database engine. Throughout the creative process, both of these technology platforms were used to experiment with the features of each platform in an effort to determine the optimum platform as a basis for CPM. Through this iterative development, the inventors discovered that both technical platforms are key enablers for the basis for a CPM solution and though each has minor advantages, both technical platforms form a part of the embodiment of the invention. In the following sections, examples are used interchangeably from both technology platforms. For example, by using the Microsoft platform, integration with e-mail such as Microsoft's Outlook can be facilitated.

The SAP processes are important processes in the day-to-day operations of sales organizations in most companies. Specifically, any company with a sales force that is global in nature and sells products and/or services through a direct sales channel to their customers, tries to have their account teams follow a consistent process in order to outline a strategy to close new business or enhance an existing position within their accounts.

SAP benefits from collaboration, fast access to information and flexible processes. Today's SAP environment is rapidly changing and, using currently available methods, account plans become out-of-date almost as soon as they are written. Because speed and flexibility are critical competitive advantages, traditional account planning approaches cannot keep pace. However, using the current invention, a SAP environment enables teams to build and execute account plans in a way that is not possible with current tools and technologies. The result is a dramatic improvement in efficiency and effectiveness that translates to lower cost-of-sales and faster revenue growth.

Similarly, understanding the position in an account, gathering and analyzing account data, setting goals, establishing responsibilities and allocating resources are as important as ever. Indeed, in today's environment, fast-response and agility are the keys to success. However, traditional account plans created with limited input, at a snapshot in time, are not effective. Today's account managers need a planning environment that is flexible, collaborative, ongoing and linked to the day-to-day management of the account. The current invention has been created to support this new way of working. The benefits of this approach in the SAP environment are substantial and include:

Faster and more effective response to customer/competitor issues leading to higher revenue growth and greater profitability

More effective execution of account plans because of the ability to collaborate around customer/competitor issues and action items

More effective decisions because of the ability to easily collaborate among multi-disciplined internal/external team members

Higher quality decision making and optimization of resources

More effective team communications

More leverage from the “Collective I.Q.” of the sales organization through the sharing of best-practices and account planning processes

A fundamental tenet of CPM is that account teams must have the ability to adapt their planning processes to the unique requirements of their customers and markets. Highly structured, generic, step-by-step, forms-based planning approaches simply do not work. In the present invention, on the other hand, adaptive capability is accomplished through team collaboration, dynamic action item management, and the ability to select only those tools that are appropriate for a given situation.

Individual tools are built in as specific steps in any process definition and through the skills and knowledge gained in becoming a skilled practitioner of using CPM for the SAP process, the user is able to quickly understand which steps and/or tools provide benefit and continually drive the process to be more effective. High-level planning processes provide the necessary direction, but flexibility and choice enables the team to quickly adapt to their fast changing environment. Studies have shown that effective plans and strategies “emerge” from the people who do the work, instead of being “formulated” by isolated planning departments. The invention provides an environment that allows plans and strategies to emerge from the agents closest to the action.

The following provides a detailed explanation of the representative embodiment of the present invention, beginning with the first key element, the process.

### The Process: Strategic Account Planning

With CPM, process steps are embedded into a collaborative platform and are tightly linked to a knowledgebase and document repository. The inventors have embodied this approach in a SAP computer system. The SAP process steps are kept at a high enough level to ensure that the system is flexible and dynamic.

Defining the process steps at a high level is essential because every customer and industry is different. Processes that are too structured, fine-grained and generic will inhibit the development and execution of account plans. The key is to identify the high-level planning steps that are common to all accounts. For example, most account managers would agree that any account plan, for any customer, should answer the following questions:

What is the business/industry of the customer?

What are the challenges, business performance, business objectives and critical success factors?

What is the team's performance (sales, cost-of-sales, market share, etc.)?

Who are the key decision-makers and what is the team's relationship with these decision-makers?

Who are the competitors and what are their strengths and weaknesses?

What are the top initiatives being pursued by the team and how do these initiatives help the customer and the team achieve their objectives?

What resources are being deployed—where and why?

What are the team's short-term and long-term objectives

By answering these questions, the account team addresses the basic issues in managing any large, complex account process. And by doing this in a collaborative environment, the team not only taps into it's “Collective I.Q.,” the present invention also ensures that everyone stays informed and coordinated. Furthermore, the team's account plan stays alive because the initiatives, action items and dialogue evolves and adapts to new conditions. This flexible and iterative approach helps to maintain a dynamic, team-selling environment.

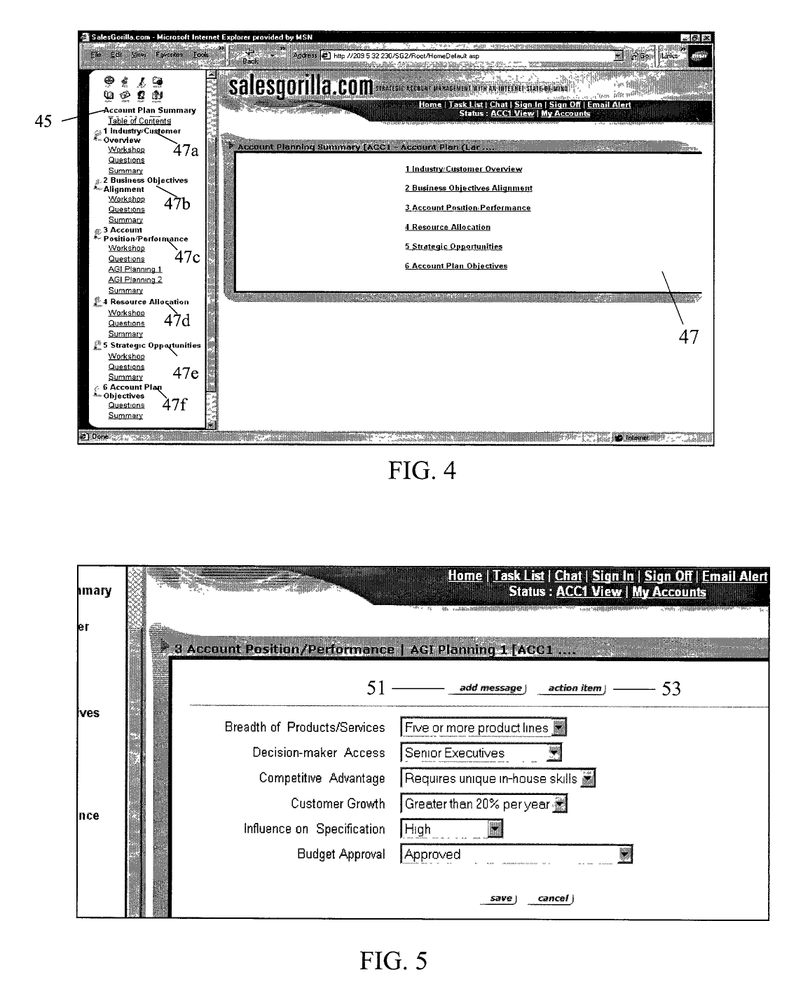

In the CPM environment, each of the foregoing questions may become the base for a step in the SAP process. Each of the steps is completed by the team, through the use of collaboration, templates and analytical tools. Although some templates and tools can be mandatory, the team must have the flexibility to select those templates and tools that are applicable to their situation. For example, in some cases, simple collaboration may be sufficient to answer a key planning question. In others, the team may need the assistance of structured templates and tools to move the planning process forward. It is also important to point out that the process is iterative—it is not a step-by-step, unidirectional methodology. A CPM SAP process in accordance with the representative embodiment of the present invention is shown in the screen image of FIG. 4.

FIG. 4 shows a six-step Strategic Account Planning (SAP) process that is outlined on vertical white bar 45 on the left side of the screen. Each of these high-level process steps becomes a line item in a Table of Contents 47 in the account plan. A summary of the working dialogue or a completed template(s) becomes the content in the Table of Contents 47.

Also, under each planning step 47a, 47b, 47c, 47d, 47e, 47f, there are three sub-headings called Workshop, Questions and Summary where team collaboration takes place. The team can also easily set up additional specific topics under each of these sub-headings (e.g., “AGI Planning 1”) in order to further focus developing dialogue. The tools and templates mentioned above are used to gather, categorize, analyze and interpret data. An example is shown in FIG. 5.

More specifically, FIG. 5 is preferably used to assess an opportunity. As the account managers or users enter data in the template, they are guided through an opportunity assessment process. An important differentiator in the CPM environment is that the users have the ability to collaborate around the templates. This is accomplished by providing links to, for example, add message 51 and action items 53. Once data is entered after accessing these links, the data resides in a database that can be queried to gain additional insights. The team preferably also has the ability to store working documents that are related to each process step in an easily accessible document repository. It is important to point out that the templates can be easily customized to focus on criteria that are relevant to a specific industry, product mix, etc. These templates can be comprehensive or simple, depending on the situation and the goals of the user's company.

It is also noteworthy that any set of process steps can be embedded in the collaboration platform of the CPM architecture. For example, in the SAP environment, the CPM architecture can be standardized or fully customized based on a particular user's needs or desires. Significantly, regardless of the specific process steps embedded in the CPM environment, collaboration, action items, knowledgebase, environmental factors, agents and the environment are tightly integrated.

### The Agents: Strategic Account Planning

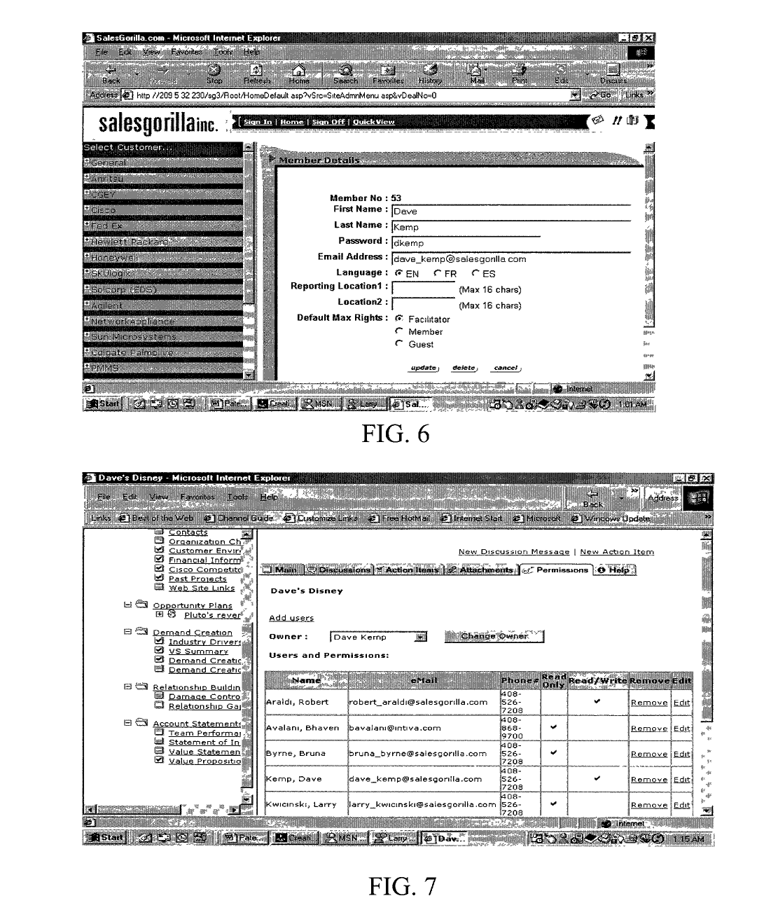

In the SAP process, people perform most of the actual work and each individual plays a distinct role in the process. From the Account Manager who is responsible for the overall SAP process and for driving the team to achieve team goals, to team members who perform much of the work, to partners who often play a key role, but normally in a more focused area of the account plan process. CPM recognizes the importance of these various role definitions and also recognizes that these roles are dynamic and that team members require the latest information regarding an individual's role to ensure the optimum management of information. FIG. 6 shows an example screen of how individual agents are granted specific roles within the CPM environment. The system uses the role definition to tailor the information that is presented to each individual agent. In this manner, the specific agent receives only the information that is pertinent for their role in the SAP process.

FIG. 7 shows how the access rights for an agent can be tailored to each specific step in the SAP process, allowing for unlimited flexibility in defining the information that is specific to certain agents, and thereby ensuring that they can focus on their effectiveness in the overall SAP process. Thus, via the exemplary screen shown in FIG. 7, it is possible to give each agent specific access rights to each step listed on the left hand side of the screen.

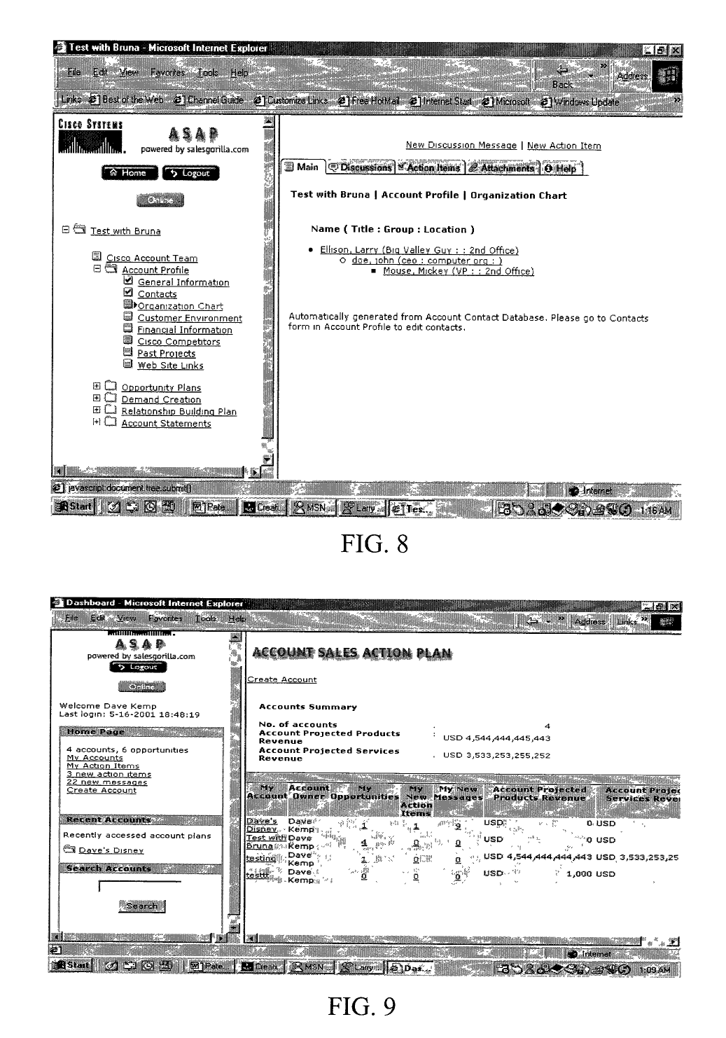

FIG. 8 illustrates how information is presented regarding the various agents involved in the SAP process and further illustrates an indication of the agents' role in the SAP process. Icons beside an agent's name may be used to indicate a level in the organization (e.g., all squares are at the same level.)

FIG. 9 embodies how information is presented using a design that strives for a balance among the various agents who require access to this type of information. From the SAP team member, this screen is used to see a snapshot of the total size of “deals” related to their account. Selecting an account allows them to drill down to subsequent levels of detail. From the managers side, the access to revenue summary data and collaboration data allows him/her to take action to ensure that the CPM system is being utilized effectively.

A second group of agents is categorized under the heading of technology (the first group being people), and comprise tight integration with existing computer systems and the Internet, to optimize the processing of information. An important result of the SAP process is to pass information, to the corporation, related to how much revenue is expected in a certain time period from a certain account. With the technical architecture of the CPM solution, this type of information is automatically rolled-up from the various levels of detail and sent to the corporate system requiring said information. Because this information is a by-product of the actual SAP process, the CPM platform ensures that this information is timely and accurate.

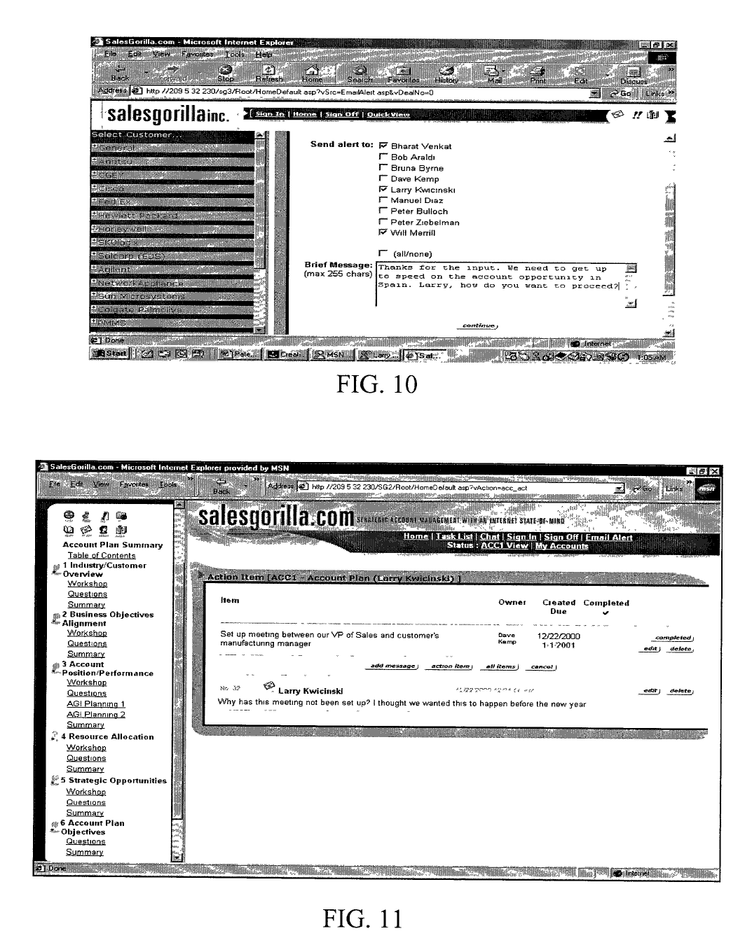

The third group of agents comprises correspondence and information and includes voicemail, e-mail, telephone, and printed media. Through integration with partners who provide telephony applications, agents are able to use the telephone from wherever they are in the world to access information from the SAP process, or to leave information for other team members to review. Printed media may be either scanned and uploaded directly into the CPM environment, or the external source locator is identified and maintained in the CPM environment. With respect to e-mail, the present invention preferably provides integration with various e-mail systems and allows a SAP team member to generate outbound messages and to also have access to e-mail messages that have been sent into the SAP process from an external source. FIG. 10 shows the integration with e-mail for outbound e-mail messages.

### The Environment: Strategic Account Planning

In the SAP process, the tangible elements that comprise the environment play important roles in optimizing the process. The SAP process described above and the agents involved in the process are tightly integrated with the other elements of the environment. The specific requirement of corporate processes are weaved into the SAP process to ensure that corporate needs are met but without sacrificing the effectiveness of the SAP process. The CPM platform of the present invention allows for the physical separation of agents working in the SAP process and with the capability for agents to work in a completely disconnected mode from any network, it ensures that agents remain motivated to use the CPM environment for all SAP related activities. The CPM environment provides for the integration of customer information and ensures that this information is available whenever an agent requires it.

The CPM environment incorporates an action item facility that is integrated with the SAP process. As agents are working through a process step and determine that an action item is required, an intelligent system agent is used to capture the action item information and link the item to the specific process step. Agents have various methods of reviewing and working with action items and the CPM platform provides the flexibility for each agent to work with action items in the manner they choose. Action items that are due are preferably highlighted to the appropriate agent with a lead time defined for these notifications. In the example of FIG. 11, the owner of an action item is being asked why an action has not yet been completed.

The two key features shown in the example of FIG. 11 are: 1) team members can easily see the action items, owners and completion dates and, 2) team members can collaborate around each action item. Theses features provide a powerful incentive to keep action items alive in a team-based environment. If conditions change and an action item is no longer applicable, the action item can be dropped or changed. Again, the entire team can adapt the account plan and the action items as conditions change.

Because of the fast-paced, competitive world of sales, most sales people are reluctant to leave the work environment to “take a training course” or “search for information.” Therefore, the knowledgebase that is integrated with the CPM platform of the present invention supports the SAP process with each step in the process. By linking relevant information to each process step, team members are only a click away from tools, assistance, and ideas to help them move forward.

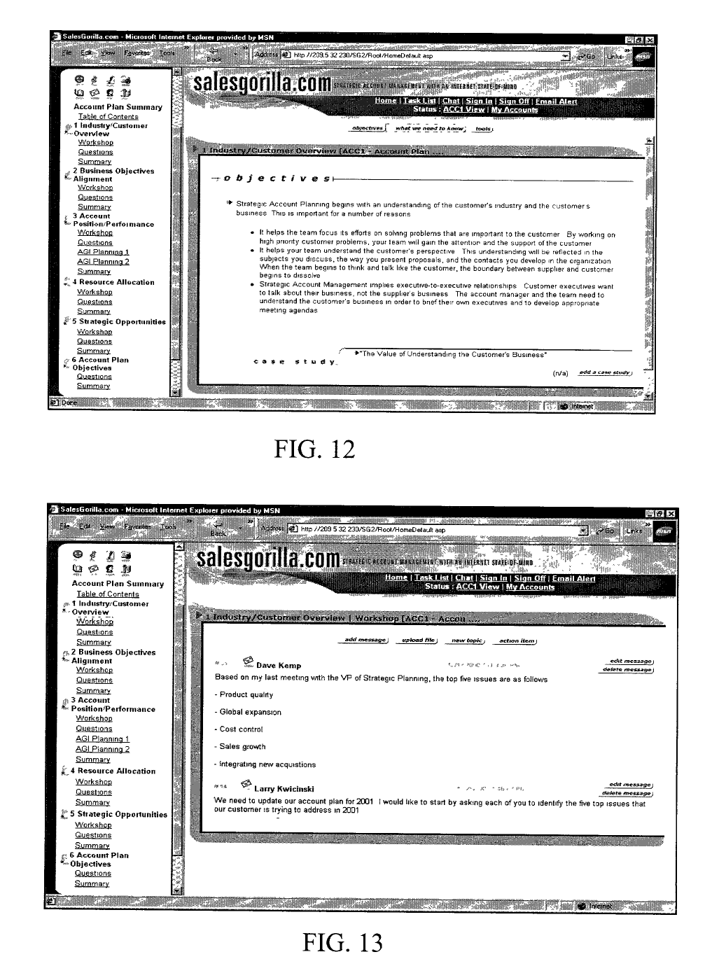

As an example, clicking on the “light bulb” beside each process step on the left hand side of the screen takes the user to the knowledgebase. If the user clicked on the “light bulb” beside “Industry/Customer Overview,” the screen of FIG. 12 would appear. In this example, the knowledgebase opens with text that describes the objectives of this particular step in the planning process. By clicking on “what we need to know” at the top of the screen, the user moves further into the knowledgebase to gain access to information such as: 1) lists of questions that need to be answered, 2) commentary, 3) case studies, 4) planning tips and, 5) tools and templates. And with the application of knowledge management software and links to existing applications, the user can also gain access to large libraries of internal information relevant to each step in the planning process.

One of the most important elements of the CPM environment is collaboration. The importance of collaboration is best summed up by a comment made by General Dwight Eisenhower: “plans are useless, but planning is essential.” Eisenhower was pointing out that in spite of the best plan, when the battle starts, unpredictable things happen. The winner of the battle is not the side with the best plan but the one that responds best to changing circumstances.

Thus, it is not surprising that account plans that are created in a snapshot of time are out-of-date almost as soon as they are written. Collaboration keeps the planning process alive and ongoing. Constant communication enables the team to respond to threats and opportunities quickly and effectively.

It is also important to remember that the communication technologies used by sales teams are varied, and tend to be mobile in nature. To provide effective communications and information access, the SAP environment preferably integrates with existing email systems, voice systems, PDAs, and installed applications. The CPM environment in accordance with the present invention also recognizes that both synchronous and asynchronous communications are important. Synchronous communications occur in the form of teleconferences, face-to-face meetings, and net meetings. Asynchronous communication occurs in the form of email, web postings and voice mail.

A typical asynchronous dialogue in the CPM environment might appear as shown in FIG. 13. In this example, the account manager is updating the account plan by asking the team to identify the top five issues that the customer will be facing in the year 2001. The collaborative dialogue that ensues generates ideas, action items and initiatives. When the dialogue in this process step is complete, the account manager summarizes the findings and posts them in the account plan. The account plan continues to evolve through further dialogue and action item management.

This example shows the flexible nature of the CPM environment. In this case, the account manager simply collaborated with the team to complete a step in the SAP process. If the account manager wanted more structure or wanted to apply an analytical tool, he/she might have selected a template from the knowledgebase. For example, on a very strategic account or for a team that does not have in depth SAP skills, the Account Manager might refer the entire team to use a template such as “How to Define an Issue” where team members would be coached on how to identify the issues from their customer's viewpoint. Members could also search the knowledge base for past case studies, or specific mini-training courses that would assist them in acquiring more advanced skills.

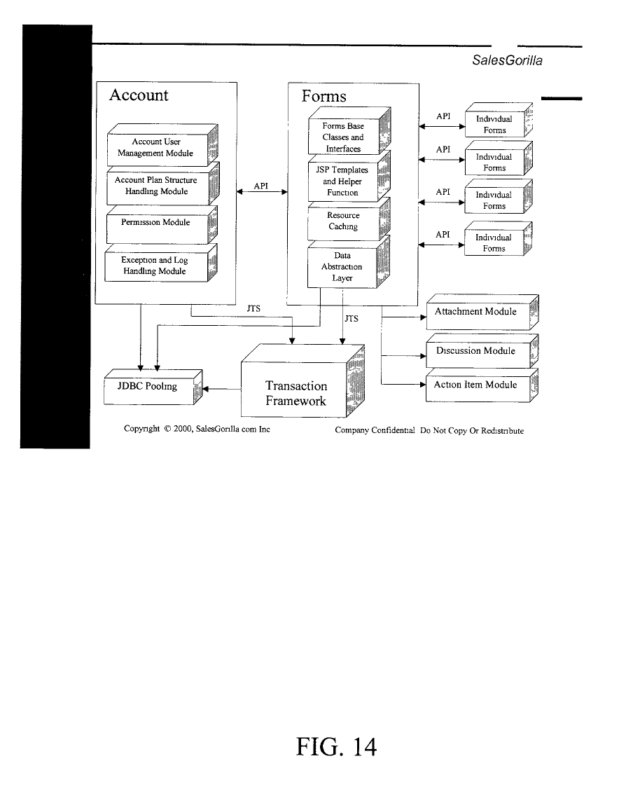

Underpinning the entire CPM environment is the technical architecture of the system. The architecture provides the infrastructure that enables process, agents, environment and environmental factors to be tightly integrated. The design of the technical architecture brings together several capabilities. The schematic diagram of FIG. 14 outlines the integrated architecture of the CPM environment in accordance with the present invention. The architecture contains three domains of components. The first domain, called the Account domain, contains four sub-components that define the structure, and functional capabilities, of the account plan (the account plan, in the case of the SAP application of the CPM system, is the set of information that embodies the account team's collective knowledge regarding a specific customer or prospect account).

The Account User Management Module contains the functionality that defines the capabilities that each class of user has the rights to use within the SAP process. As each user is defined a role in the process, each role is granted a series of functions or access to data. A series of API's exist for other sub-components to access these services.

The Account Plan Structure Handling Module contains the functionality on how the system allows users to navigate within the account plan, provides the flexibility in account plan setup, and defines a series of Application Program Interfaces (API) that allow other system domains to interact with this sub-component to request either data managed by the sub-component, or to request services provided by the sub-component.

The Permission Module contains services that manage the authority and access rights for specific agents in the SAP process. The agent's specific access rights information is stored in the database, and through API's, this sub-component offers any permission related service to other components such as validation of an agents access rights and the granting of permission for an agent to access certain steps in the SAP process.

The Exception and Log Handling Module provides services to all system components for storing a log of actions that have taken place in the system, and for dealing with exception situations to ensure that the integrity of the system is maintained when an error situation occurs. These services are offered to all system components via a set of API's.

The second domain is the Forms domain and is the source for defining the flexibility in the functionality of the forms or templates used in the definition of the SAP process. In FIG. 14, the Forms domain interfaces with individual Forms with a defined API for each physical form. These forms are the specific tool or template associated with a step in the process.

The Forms Base Classes and Interfaces, define the common functions that are available to the other system components for using the various forms. For example, the navigation characteristics associated with forms are maintained in this sub-component.

JSP Templates and Helper Function provides services that aid in the creation and operation of the individual forms. Using the templates assists in the customization of the SAP process. JavaServer Pages™ (JSP™) technology allows system developers and designers to develop and maintain, information-rich, dynamic web pages.

Resource caching provides services to increase the overall speed and efficiency of the system by storing data that has been recently used in the event that a user wishes to access this data again. By caching this type of data, the system can minimize Input/Output operations that can slow down the responsiveness of the overall system.

Data Abstraction Layer provides a succinct interface layer that shelters other system components from having to be fully aware of the detailed database structure of the system. This sub-component defines a series of data services that are coherent from a business perspective and hence can be easily utilized by other domains. The actual physical complexities of the various data table relationships is defined in this subcomponent. This portion of the overall system architecture substantially increases the effectiveness of any system modification activities and as a result ensures that the integrity and ability to respond rapidly to customization is available to system users.

The third domain contains a series of sub-components that form the transactional basis for the system. As system users perform various functions of the SAP process, their requests are routed to the Transactional Framework where the system determines how best to complete the user's request.

JDBC Pooling provides system performance functionality and enables the system to optimize requests to the database and to ensure that provision of data to satisfy user requests is completed in the most technically proficient manner possible. JDBC™ technology allows access to a data source from the Java™ programming language.

The Attachment Module contains all functional services associated with the ability to store attachment and embed them within the SAP process. Specific information regarding each attachment is stored with the attachment to facilitate access by other domains.

The Discussion Module contains all functional services associated with processing and storing the information resulting from dialogue threads and collaboration in the system. Important collaboration information such as the user identification, timestamp and the associated step in the process are stored and made available to other domains that require access to the information.

The Action Item Module contains all functional services associated with processing and storing the information related to the creation and tracking of Action Items in the system. Important information such as the user identification, timestamp, target completion date and the associated step in the process are stored and made available to other domains that require access to the information.

The Transaction Framework is the heart of the system and is in effect the sub-component that codifies the inter-relationships between the various other sub-components. Within the system architecture, each of the sub-components described above provides a specific set of services and stores the data relevant to the specific service. The Transaction Framework is responsible for ensuring that the linkages between the various domains are coherent and that requests from specific system users can be processed and the integrity of the technical processing is assured. The Transaction Framework uses Java™ Transaction Service (JTS) which specifies industry standards for the services provided by a transaction manager.

As depicted in FIG. 14, the core CPM functions are architecturally separate entities but tightly bound to become an integrated process engine that provides an effective vehicle to perform the various business transactions that occur as a part of the SAP process.

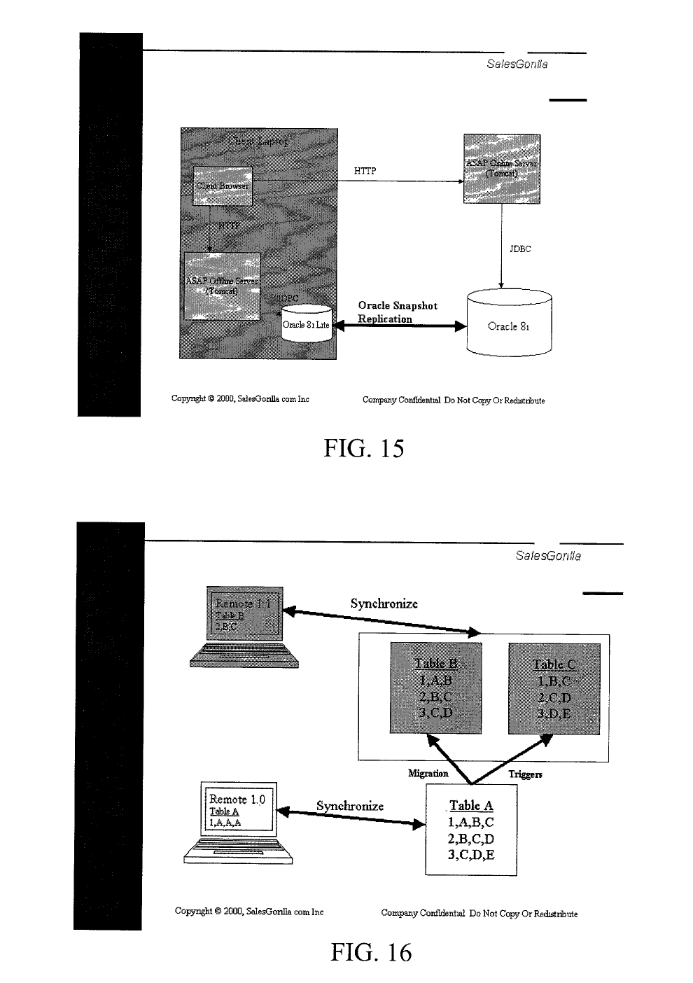

One of the key capabilities of the CPM environment is the ability for agents to work in either a connected mode where they are connected to a network, or in a disconnected mode where no network connection is possible. This capability is desirable in order to recognize the physical world of agents. From an architectural perspective, logic is preferably embedded in the CPM environment to ensure that the integrity of the SAP processes are maintained when a previously disconnected agent, connects and wishes to synchronize their work into the SAP process being worked on by the team. A diagram depicting the online/offline architecture is illustrated in FIG. 15. The system preferably utilizes standard industry technology such as Tomcat web server and Oracle database technology. These standard technologies offer robust capabilities to ensure that the technical integrity of the various data bases in the system are secured. The transactional Framework as depicted in FIG. 14 offers a series of controls that extend the standard services offered by Tomcat and manages the offline capability offered by the CPM system. For example, the system offers the capability for users to have versions of a form to be checked out to a user's offline environment and by storing various important pieces of data associated with the date, users profile, and version information, the system can ensure that updates to the form are controlled and that all team members have access to the latest version of a specific form and that data contained in the form is of the highest integrity.

Another capability of the CPM environment is the ability to upgrade agents to new versions of the software in a non-intrusive manner. The CPM environment contains well-known algorithms to determine the version of software that a specific agent is using and to apply a sequence of fixes and enhancements, in order to upgrade the agent's environment to the current correct version. The architecture for this feature is outlined in FIG. 16, in which an agent machine running an old version of the CPM environment is automatically migrated by applying various data table updates and a re-fresh of the agent's environment.

### The Environmental Factors: Strategic Account Planning

In the SAP process, the intangible elements that comprise the environment play important roles in optimizing the process. The design of the CPM system and method, particularly in view of the SAP process, has been performed taking into account indepth analysis of the psychology and skills and knowledge of agents who are targeted as users of the system, and taking into account a clear understanding of the relationships between various agents and the impact of communication between them. The design of the CPM invention has been strongly influenced by the inventors belief that the agents in the SAP process need extreme flexibility in the execution of processes and complete integration of all the features they will require as they work on SAP processes.

### CPM Processes: Perform Work

Distinct from the specific SAP process that is identified and embedded into the CPM system, there are a number of functions that human agents are responsible for on an ongoing basis as a part of participation in the SAP process. These functions comprise the “marching orders” for a SAP team and these agents, with an understanding of the CPM environment, environment factors, the specific SAP process steps and the CPM software system, are well armed to drive an effective SAP process.

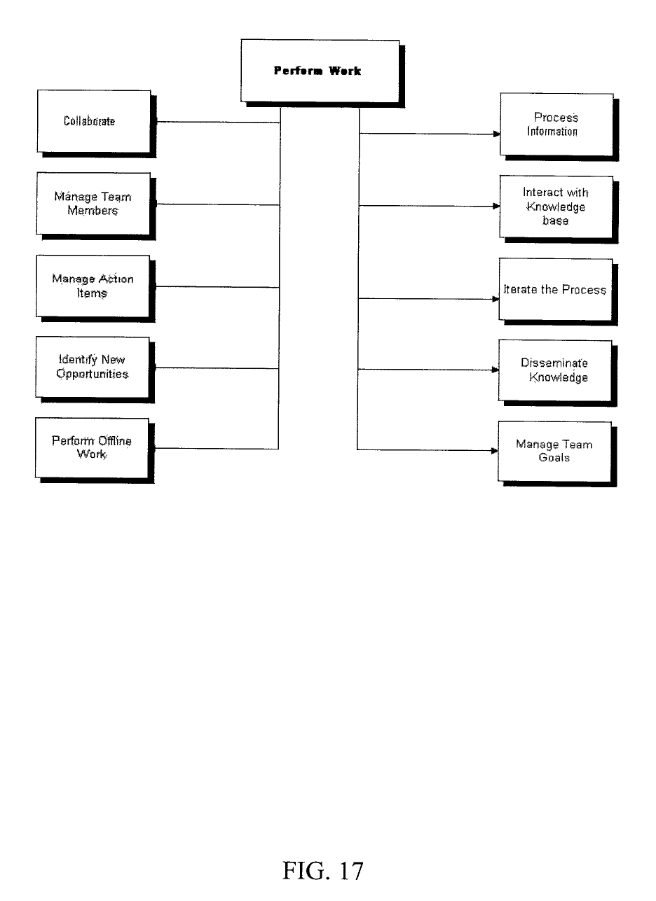

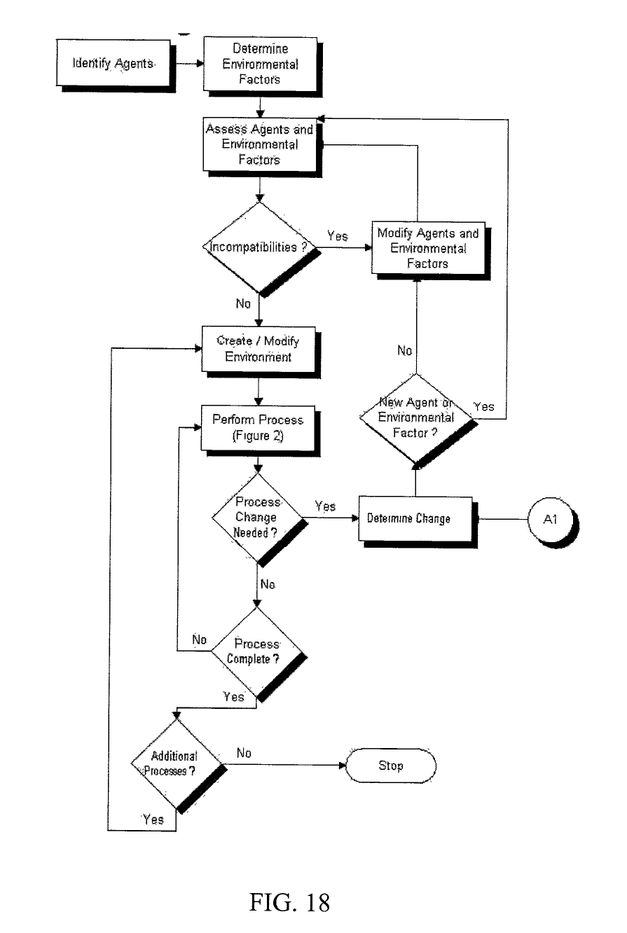

The specific functions that SAP agents are responsible for are listed here and illustrated in FIG. 17:

Collaboration: each member alternates continually between being a providor of information and a recipient of information. Collaboration between team members is crucial to effectively running SAP teams.

Manage team members: with the embedded action item features, agents learn to manage themselves and look to other team members to do likewise.

Identify New Opportunities: SAP teams need to continually generate new accounts and often the collaboration features are responsible for many new leads.

Perform offline work: agents require the facility to work while connected and unconnected.

Process Information: agents receive a constant bombardment of information from sources that must be processed and decisions are required as to the disposition of each piece of information.

Interact with the knowledgebase: agents must constantly tap the knowledgebase for new information and tips and tools that help them to become more efficient.

Iterate the process: agents in the SAP process realize that there is no linear approach to sales in this complex area, and as a result are very good about using pieces of the process that bring them closer to their objectives.

Disseminate knowledge: in the collaborative SAP world, agents know there is much to be gained through disseminating information that can be beneficial to the team.

Manage team goals: as team goals are maintained in the CPM product, each team member has a good view of the expectation from each team member, and uses the open visibility afforded through use of the system.

### CPM Processes: SAP Set-up

As depicted in FIG. 18, the SAP process begins with the Account Manager typically identifying the agents that will comprise the team. Once identified, these individuals are created on the CPM system and appropriate access rights and permissions are granted to them. Next the Account Manager assesses the environmental factors and determines the impact on the SAP process.

For example, the Account Manager who has been skilled in working with the CPM process, performs an analysis of the blend of the skills and knowledge of the team members with respect to SAP, their individual psychological make-up, the specific corporate culture and other environmental factors. The skilled Account Manager determines the approach that is best for the specific account being worked on and the Account Manager can make changes to the CPM system to adapt it to the various factors he/she feels are most important for the overall effectiveness of the process. For example, if the Account Manager determines that the corporate culture requires formal status reporting to management regarding account status, that the team is not very skilled in SAP knowledge, that the team is dispersed and has not had previous experience dealing with each other, and that members are highly motivated by achievement, the Account Manager can set up the CPM system to have a very structured report for submitting status information and will create this in the CPM system as a form or template and inform all members that once a week they must complete the form in order to ensure that the team satisfies the needs of the management of the corporation.

Given all the other factors, the Account Manager can ensure that members work in a more collaborative style with strong utilization of the knowledgebase for expanding the skill and knowledge of each member. The loose collaboration is be fostered to minimize the impact of the physical separation and in order to keep members motivated, the account manager will focus attention on only those sections of the process that are directly needed to achieve the goal of closing a new deal. If the Account manager had performed his/her analysis of all the factors, and found a different blend, he/she would have re-configured the process and managed the team with emphasis on other of the key capabilities available via the CPM system.

Next the Account Manager assesses the compatibility between the agents and the environmental factors. Conflicts between the personal style of an agent and a corporate culture for example, would be cause for the Account Manager to modify one or the other and loop back to the assessment step. If all appears compatible, the CPM environment is created with definition of all agent information and environment information.

The SAP team is now ready to begin actually performing work. The specific responsibilities of team members have been described above (and illustrated in FIG. 17), and the team works through the SAP process constantly interacting between collaboration, working on action items, learning new skills or information, and identifying opportunities to change the actual SAP process. If no changes are identified, then the process continues until the objectives are met. If changes are identified, the team or the Account Manager assess the change and modify the CPM environment or the agents accordingly.

This process has no defined time limit and in fact varies widely from one team to another, from one account to another, and one company to another. The key similarity is that the process continues in the iterative fashion until the objectives are met, and all communication, action items, documents, and decisions are saved in the CPM system.

### CPM Processes: Perform Process

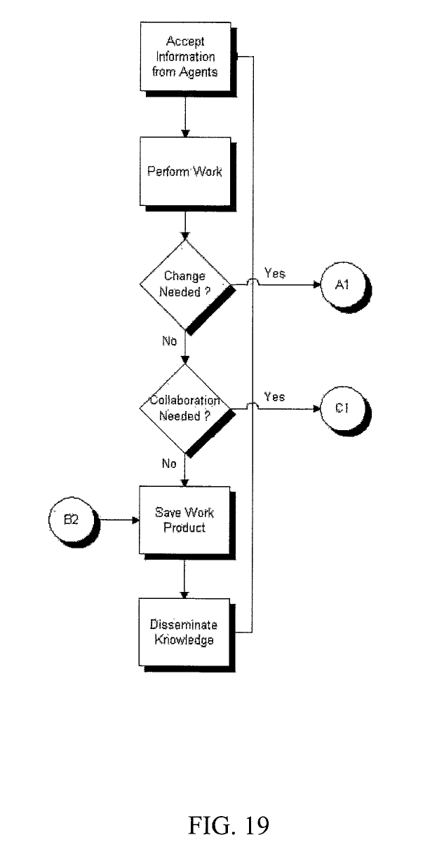

As depicted in FIG. 19, as an agent works on the SAP process he/she/it will be constantly receiving information from other agents and must constantly assess whether either collaboration is needed among other agents or that a change to the SAP process is indicated. As pieces of the SAP process are completed, the agent ensures that the information stored on the CPM system is complete and then determines if other agents should be notified.

### CPM Processes: Collaborate

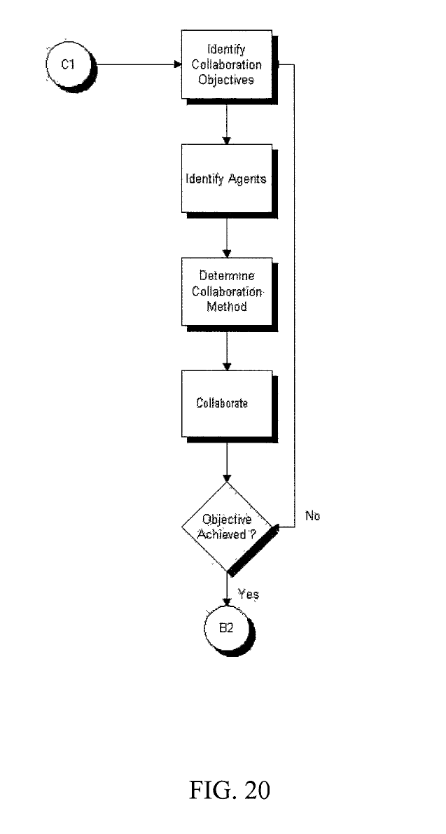

The collaboration process is initiated, as shown in FIG. 20, by an agent who first determines that collaboration would assist the SAP process. The need for collaboration can arise from any point in the SAP process. The first activity is to determine the objective for the collaboration and then to identify the agents that should be involved in the collaboration. In most SAP processes, all the members of the team are potential candidates for the majority of collaboration as they are all working on a common goal. The next step is to determine the best method for the collaboration. The agent has a number of methods to choose from including use of the CPM system, e-mail, voicemail, conference call or face to face meeting. In all cases, the result of the collaboration is preferably posted to the CPM system so that all team members have instant access to the latest thoughts and actions being worked on in the SAP process. Collaboration is often a springboard to identifying additional items that require definition or resolution and quite often several iterations of a collaborative session are needed before the actual objective is achieved. In each case, the results are preferably captured in the CPM system.

The foregoing disclosure of the preferred embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A collaborative process management method, comprising the steps of:
identifying agents;
determining environmental factors;
assessing the agents in view of the environmental factors;
creating an environment in which the agents can communicate with one another;
embedding a process in the environment;
performing the process; and
facilitating collaboration among the agents during the process performing step.

2. The method of claim 1, wherein the process is conducted via a web browser.

3. The method of claim 1, further comprising employing the internet for the step of facilitating collaboration.

4. The method of claim 1, wherein the agents comprise at least one of a person, voicemail, email, printed media, telephone, correspondence, a computer system, and the internet.

5. The method of claim 1, wherein the environmental factors comprise at least one of skill and knowledge, psychology, interaction between agents, relationships between agents, corporate culture, and human communication interaction.

6. The method of claim 1, wherein the environment comprises at least one of an account planning process, a technical architecture, customer information, a knowledgebase, collaboration, agents, a corporate process and an action item.

7. The method of claim 1, wherein collaboration comprises generating action items.

8. The method of claim 1, wherein collaboration comprises changing the process.

9. The method of claim 1, further comprising managing team members.

10. The method of claim 1, further comprising managing action items.

11. The method of claim 1, further comprising identifying new opportunities.

12. The method of claim 1, further comprising performing work offline and subsequently synchronizing when online.

13. The method of claim 1, further comprising interacting with a knowledgebase.

14. The method of claim 1, further comprising disseminating knowledge that was previously saved.

15. The method of claim 1, further comprising managing team goals.

16. A method of executing collaborative process management, comprising the steps of:
assessing agents and environmental factors;
creating an online environment that promotes collaboration among the agents in view of the environmental factors;
embedding a process having a plurality of steps in the online environment;
offering an opportunity to the agents within the online environment to collaborate with respect to any one of the steps of the process; and
modifying the process in view of proposals resulting from collaboration among the agents.

17. The method of claim 16, further comprising offering to agents access to a knowledgebase.

18. The method of claim 17, wherein the knowledgebase comprises cases studies.

19. The method of claim 16, further comprising employing templates to promote collaboration.

20. The method of claim 16, wherein the step of offering an opportunity to the agents within the online environment to collaborate comprises providing access to at least one of a messaging system and an action item list.

21. The method of claim 16, wherein the process comprises strategic account planning.

22. The method of claim 16, further comprising:
acting on action items developed as a result of collaboration;
learning new skills via a knowledgebase; and
identifying new opportunities developed as a result of collaboration.

23. The method of claim 16, wherein the online environment is established over the internet.

24. The method of claim 23, wherein the online environment is accessible via a web browser.

25. The method of claim 16, wherein the agents comprise at least one of a person, voicemail, email, printed media, telephone, correspondence, a computer system, and the internet.

26. The method of claim 16, wherein the environmental factors comprise at least one of skill and knowledge, psychology, interaction between agents, relationships between agents, corporate culture, and human communication interaction.

27. The method of claim 16, wherein the environment comprises at least one of an account planning process, a technical architecture, customer information, a knowledgebase, collaboration, agents, a corporate process and an action item.

28. A system for implementing collaborative process management, comprising:
a first domain comprising modules representative of a process;
a second domain comprising forms and a data abstraction layer; and
a third domain comprising a transaction framework and being connected to both the first domain and the second domain,
wherein first, second and third domains are in communication with each other such that collaboration around selected process steps is promoted.

29. The system of claim 28, wherein the process is account planning.

30. The system of claim 29, wherein first domain comprises at least one of an account user management module, an account plan structure handling module and a permission module.

31. The system of claim 28, wherein the second domain comprises templates.

32. The system of claim 28, further comprising an attachment module.

33. The system of claim 28, further comprising a discussion module.

34. The system of claim 28, further comprising an action item module.

35. The system of claim 28, wherein users access at least portions of the system via a browser.

36. The system of claim 28, wherein first domain and second domain are operable together to promote collaboration among agents.

37. The system of claim 28, wherein the domains are bound via software.

38. The system of claim 28, further comprising a knowledgebase that is accessible to users.

39. A system for encouraging collaboration among agents in a process, the system comprising:
means for identifying agents;
means for determining environmental factors;
means for assessing the agents in view of the environmental factors;
means for creating an environment in which the agents can communicate with one another;
means for embedding a process in the environment;
means for performing the process; and
means for facilitating collaboration among the agents during the process performing step.

40. The system of claim 39, wherein the process is conducted via a web browser.

41. The system of claim 39, wherein the internet is employed to facilitate the collaboration.

42. The system of claim 39, wherein the agents comprise at least one of a person, voicemail, email, printed media, telephone, correspondence, a computer system, and the internet.

43. The system of claim 39, wherein the environmental factors comprise at least one of skill and knowledge, psychology, interaction between agents, relationships between agents, corporate culture, and human communication interaction.

44. The system of claim 39, wherein the environment comprises at least one of an account planning process, a technical architecture, customer information, a knowledgebase, collaboration, agents, a corporate process and an action item.

45. The system of claim 39, further comprising an action item module.

46. The system of claim 45, wherein the system offers access to the action item module during the performance of steps in the process.

47. The system of claim 39, further comprising means for synchronizing offline and online users.

48. The system of claim 39, wherein the process is strategic account planning.

49. The system of claim 39, wherein the system is operable from at least one server.

50. The system of claim 39, wherein the server is connected to the internet.
